(19) United States
(12) Patent Application Publication
(10) Pub. No.: US 2022/0225652 A1
(43) Pub. Date: Jul. 21, 2022

(54) SAPONIN COMPRISING COMPOSITIONS

(71) Applicant: CORN PRODUCTS DEVELOPMENT, INC, WESTCHESTER, IL (US)

(72) Inventors: Justin DERSH, Bridgewater, NJ (US); Quyen NGUYEN, Bridgewater, NJ (US); Brandon ROA, Bridgewater, NJ (US); Bicheng WU, Bridgewater, NJ (US); Erhan YILDIZ, Bridgewater, NJ (US)

(21) Appl. No.: 17/614,633

(22) PCT Filed: Jun. 5, 2020
(86) PCT No.: PCT/US2020/036247

§ 371 Date: Nov. 29, 2021

Related U.S. Application Data
(60) Provisional application No. 62/859,484, filed on Jun. 10, 2019.

(51) Int. Cl. A23L 29/212; A23L 27/60; A23L 29/10

(52) U.S. Cl. CPC A23L 29/212; A23L 29/10; A23L 27/60

(57) ABSTRACT

This specification discloses a saponin containing composition derived from flower seeds, or carnation flower seeds. The composition may comprise between 2% and 90%, saponin content by weight, and may be a powder or a liquid. Such compositions may also comprise other components of the carnation seed including protein, starch, and fiber. The disclosed compositions are useful as emulsifier and for use in food composition where a saponin containing composition may be used in amounts between 0.01% and 50% by weight of the composition.

### CROSS-REFERENCE TO RELATED APPLICATION

This application claims the benefit of U.S. Provisional Patent Application No. 62/859,484, filed Jun. 10, 2019, which is incorporated by reference herein in its entirety.

The present invention relates to saponin containing compositions derived from the seeds of flowering plants and more particularly to saponin containing compositions obtained from prairie carnation seeds.

In various embodiments, this specification discloses a saponin containing composition that comprises, consists essentially of, or consists of saponins that occur naturally within seeds of a flowering plant. In various other embodiments, this specification discloses a saponin containing composition that comprises, consists essentially of, or consists of components of a milled flower seed having high natural saponin content. In still other embodiments, this specification discloses a saponin containing composition derived from the milled components of a flower seed the composition having increased saponin content compared to the naturally occurring saponin content in the seed. In still other embodiments this specification discloses a saponin containing composition that is derived from the seed of flowering plants and further comprises at least one of a starch, protein, or fiber that naturally occurs within the seed. In still other embodiment this specification discloses a saponin containing composition derived from a flowering plant that comprises one or more seed components selected from the group of starch, protein, or fiber, such component existing in an amount in the composition that differs from an amount such component naturally exists in the seed. Also described in this specification are methods for making a saponin composition, uses for a saponin composition, food products comprising a saponin containing composition, and methods for making a food product comprising a saponin containing composition.

The invention is further described by the following figures which describe embodiments illustrative embodiments of the saponin containing composition and food products made using the compositions. The figures are not limiting in any way.

### DESCRIPTION OF THE FIGURES

FIG. 1 reports the mean oil droplet size of spoonable dressings (oil-in-water emulsions) made using various emulsifiers.

FIG. 2 reports the instability index of an Alfredo sauce (oil-in-water emulsions) made using various emulsifiers.

FIG. 3 provides the particle size distribution of illustrative saponin containing compositions.

FIG. 4a provides the oil droplet size distribution for instant emulsions using illustrative embodiments of a saponin containing composition.

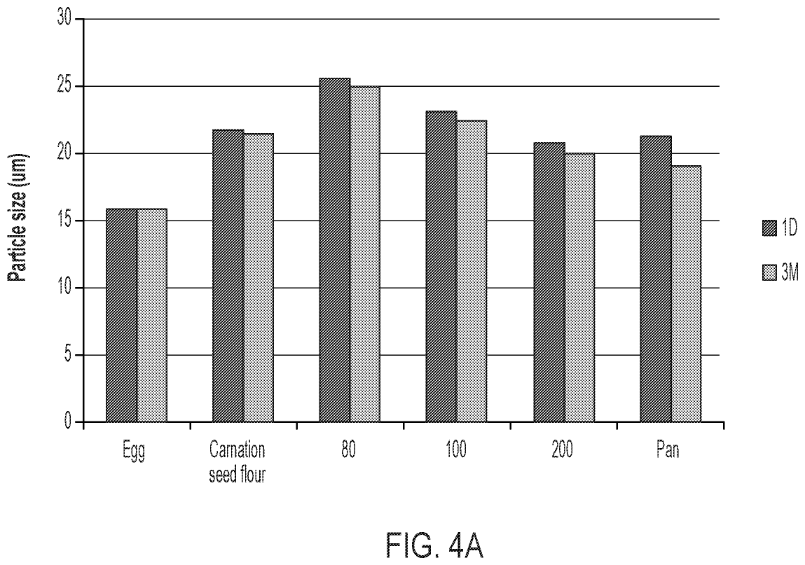

FIG. 4b provides the Hunter L value for instant emulsions using illustrative embodiments of a saponin containing composition.

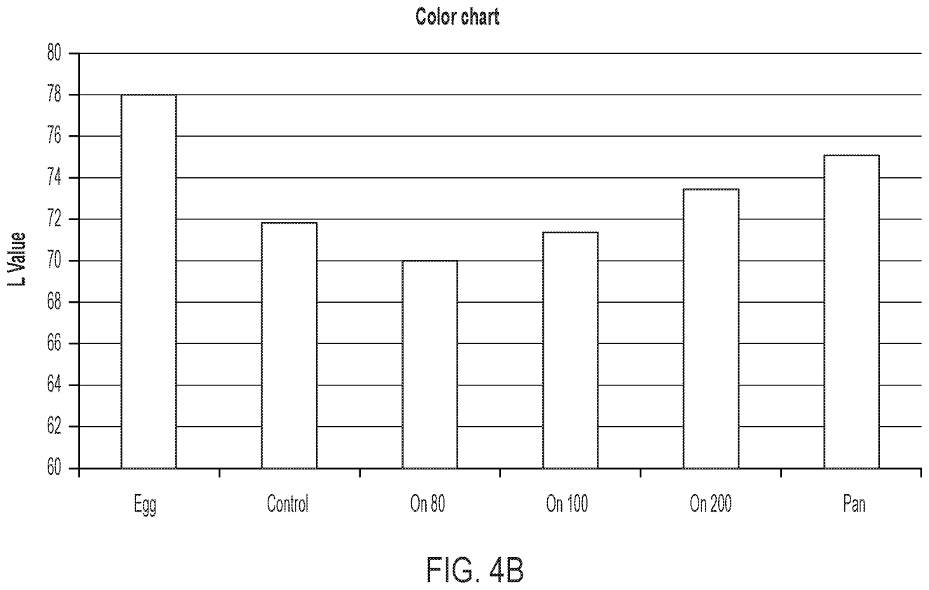

FIG. 5 provides the oil droplet size distribution for cook-up emulsions using illustrative embodiments of a saponin containing composition.

FIG. 6a provides the viscosity over time of eggless emulsions using illustrative embodiments of a saponin containing composition.

FIG. 6b provides the instability index of eggless emulsions using illustrative embodiments of a saponin containing composition.

FIG. 7 provides the oil droplet size distribution for high fat emulsions using illustrative embodiments of a saponin containing composition

In one aspect this specification discloses a saponin containing composition. In embodiments a saponin containing composition is derived from seeds having high saponin content. In embodiments a saponin containing composition is derived from the seeds of carnation flowers. For example, seeds from flowers of the genus Vaccaria or flowers of the species V. hispanica. In at least one embodiment this specification discloses a saponin containing composition that is derived from a prairie carnation seed (V. hispanica). In one or more embodiments a saponin containing composition is a flour, a saponin enriched flour, or a saponin extract. In an illustrative embodiment, prairie carnation seed may be milled to obtain a flour comprising starch, lipids, proteins, saponins, and fiber. Table 1 provides the weight percentage of various components of an illustrative prairie carnation seed flour.

TABLE 1
Components of a Carnation Seed Composition

| Component | Content (w/w %) |
|---|---|
| Starch | 61.7 |
| Protein | 13.6 |
| Lipid | 4.3 |
| Saponins | 2.9 |
| Cyclopeptides | 0.2 |
| Phenolics | 0.5 |
| Other fractions | 16.8 |
| Total | 100 |

In various embodiments a saponin containing composition derived from a carnation seed comprises total dietary fiber of about 14.6% (w/w), and/or a soluble fiber content of about 12.3% (w/w).

In embodiments a saponin containing composition has the same or different amount of saponin content relative to the contents of the seed it is derived from. In certain embodiments, a saponin containing composition comprises between about 1% and essentially 100% flower seed saponin. In some embodiments, a saponin containing composition comprises flower seed saponin in an amount between about 2 and about 90% by weight. In some embodiments, a saponin containing composition comprises flower seed saponin in an amount between about 2% and about 20%, between about 2% and about 15%, between about 2% and about 10%, between about 2% and about 7%, between about 2% and about 6%, between about 2% and about 5%, or between about 2% and about 4%. In other embodiments a saponin containing composition comprises flower seed saponin in the amount between about 10% and about 50%, saponin, or between about 10% and about 45%, or between about 10% and about 40%, or between about 15% and about 40%, or between about 15% and about 39%, or between about 15% and about 37%, between about 20% and about 37%, between about 20% and about 35%, between about 20% and about 33%, or between about 20 and about 30%. In other embodiments a saponin containing composition comprises flower seed saponin in an amount greater than about 60% or between about 50% and about 90%, between about 50% and about 75%, between about 50% and about 67%, or between about 50% and about 60%. In certain embodiments, the saponin containing composition may a powdered composition or a liquid composition.

In some embodiments a saponin containing composition is a powdered composition derived from carnation seed or prairie carnation seed and has a protein content less than occurs naturally in the seed. In various embodiments, a powdered saponin containing composition has protein content less than about 10%, less than about 7%, less than about 5%, less than about 4%, or less than about 2% or between about 0.1% and about 10% by weight. In other embodiments a saponin containing composition is in powdered form and is derived from one or more of carnation seed or prairie carnation seed and has a protein content higher than occurs naturally in the seed. In various embodiments a powdered saponin containing composition comprises a protein content between about 15 and about 50% of the composition, or between about 15% and about 40%, or between about 15% and about 30%, or between about 15% and about 25% or between about 15% and about 20% of the composition.

In embodiments a saponin containing composition is in powdered form and is derived from carnation seed, or prairie carnation seed, and has a different amount of starch than is present in the native seed. In embodiments a powdered saponin containing composition has a starch content less than what naturally occurs in the seed. In other embodiments a powdered saponin containing composition has a starch content greater than what is naturally present in the seed. In various embodiments a powdered saponin containing composition comprises 40% and 80% starch by weight, or between about 45% to about 60%, or between about 45% to about 55%, or between about 45% and about 50%, or between about 50% and about 55% or between, about 50% and about 60%, or between about 55% and about 60%, or between about 60% and about 80% starch, or between about 60% and about 75%, or between about 60% and about 70%, or between about 61% and about 70%, or between about 62% and about 70%, or between about 63% and about 70%, or between about 64% and about 70%, or between about 65%, and about 70%, or between about 65%, and about 71%, or between about 65% and about 72%, or between about 65% and about 73%, or between about 65% and about 74%, or between about 65% and about 75%.

In still other embodiments a saponin containing composition, is in powdered form and is derived from one or more of carnation seed or prairie carnation seed and has higher or lower fiber than naturally occurs in the seed. In various embodiments a powdered saponin containing composition comprises less than about 10% fiber, or less than about 7%, or less than about 5%, or less than about 3%, or less than about 1%, or between about 0.1% and about 10% by weight of the composition.

In various embodiments, a saponin containing composition is in powdered form and has a particle size distribution. In various embodiments a saponin containing composition is derived from a seed flour and has a particle size distribution that is different than a particle size distribution of the flour. In some embodiments a saponin containing composition is modified from a seed flour to have generally smaller particles than the seed flour. In some embodiments a powdered saponin containing composition has a particle size smaller than about 80 mesh, or smaller than about 100 mesh, or smaller than about 120 mesh, or smaller than about 140 mesh, or smaller than about 170 mesh, or smaller than about 200 mesh, or smaller than about 230 mesh, or between about 80 mesh and about 230 mesh, or between about 80 and about 200 mesh, or between about 80 and about 170 mesh, or about 100 mesh and about 170 mesh, or between about 100 mesh and about 200 mesh, or between about 100 mesh and about 230 mesh, or between about 120 mesh and about 230 mesh, or between about 140 mesh and about 230 mesh, or between about 170 mesh and about 230 mesh, or about 200 mesh. In other embodiments a powdered saponin containing composition has a particle size distribution having a mode of between about 10 and about 300 microns, or between about 10 and 250 microns, or between about 10 and about 200 microns, or between about 10 and about 150 microns, or between about 10 and about 100 microns or between about 10 and about 40 microns, or between about 50 and about 300 microns, or between about 50 and about 250, or between about 50 and about 200 or between about 50 and about 150, or between about 50 and about 100, or between about 50 and about 70 microns, or between about 100 and about 200 microns, or between about 200 and about 300 microns. In embodiments a saponin containing composition consists essentially of carnation seed saponin, and optionally has a particle size distribution having a mode between about 10 and about 40 microns.

In embodiments a saponin containing composition is a liquid composition obtained from components of one or more of a carnation seed or prairie carnation seed and having a saponin content. In embodiments a liquid saponin containing composition obtained from one or more of a carnation seed or a prairie carnation seed and the composition comprises saponin at between about 10% and about 50%, or between about 15% and about 37%, between about 20% and about 37%, between about 20% and about 35%, between about 20% and about 33%, or between about 20 and about 30%. In embodiments a liquid saponin containing composition obtained from a carnation seed, or a prairie carnation seed comprises saponin in an amount between about 50% and about 90%, between about 50% and about 75%, between about 50% and about 67%, or between about 50% and about 60%.

In another aspect this specification discloses methods for making the above described compositions. In an embodiment, a method for making a saponin containing composition comprises obtaining a flour from a seed having a saponin content and removing at least a portion of one or more of a protein or starch from the flour. In some embodiments a method for making a saponin containing composition comprises obtaining a flour from a seed having saponin content and removing substantially all starch, protein, and fiber from the composition to obtain a composition that consists essentially of saponin. In various embodiments the method for making a saponin containing composition comprises removing at least a portion of one or more of protein or starch from the flour by use of a dry method or wet method. An illustrative dry method useful for making a saponin containing composition comprises air classification, which is a process that use air counter currents to separate components of a powder based on differences in their relative physical properties. Another illustrative dry method embodiment is sifting a prairie carnation seed flour. An illustrative wet method useful for making a saponin containing composition comprises centrifugal decantation, which is a process to separate a dissolved phase from a dispersed phase. Some embodiments of a wet process useful for making a saponin containing composition further comprise retaining a dissolved phase and concentrating the dissolved phase using one or more of evaporation, spray drying, freeze drying, ultrafiltration, nanofiltration, forward osmosis, and reverse osmosis. Some embodiments of a wet method useful for saponin containing composition further comprise precipitating and/or recovering a solid saponin.

In one illustrative embodiment a method of making a saponin containing composition comprises obtaining a milled carnation seed, separating at least a portion of the components of the milled carnation seed, using dry method wherein the seeds are separated based on at least one physical characteristic of the respective component, and wherein the process produces a powdered composition having a particle size distribution having a mode of between about 50 and about 70 microns, or between about 100 and about 200 microns, or between about 200 and about 300 microns.

In one illustrative embodiment, a method of making a saponin containing composition comprising soaking at least a portion of a carnation seed in an aqueous solution to obtain a saponin containing composition having between about 50 and about 90% by weight carnation seed saponin content.

In another aspects, this specification discloses food compositions comprising a saponin containing composition. In at least one embodiment a saponin containing composition is useful as an emulsifier in a food composition. In some embodiments the composition is useful as the sole emulsifier in a food composition. In another embodiment a saponin containing composition is useful as an emulsifier and a stabilizer in a food composition. In at least one embodiment this specification discloses a food composition comprising a powdered saponin containing composition. In at least one other embodiment this specification discloses a food composition comprising a saponin a liquid saponin containing composition. In various embodiments a food composition (or food product) comprises a saponin containing composition in an amount between about 0.01% and about 50% by weight of the food composition, or between about 0.1% and about 10%, or between about 0.1% and about 5% or between about 0.1% and about 2.5% or between about 0.1% and about 2% or between about 0.1% and about 1.5% or between about 0.1% and about 1.4% or between about 0.1% and about 1.3% or between about 0.1% and about 1.2% or between about 0.1% and about 1.1% or between about 0.1% and about 1% or between about 0.2% and about 1% or between about 0.3% and about 1% or between about 0.4% and about 1% or between about 0.5% and about 1% or between about 0.6% and about 1% or between about 0.7% and about 1% or between about 0.8% and about 1%.

In certain embodiments, a food composition comprises a saponin containing composition and a second edible ingredient. Illustrative second ingredients include, for example, but are not limited to egg yolk, sweeteners (e.g. sucrose, rabaudioside, allulose, corn syrup, glucose), salts, seasonings commonly used in edible compositions, dairy ingredients whether liquid (milk, cream), solid (cheese, butter, non-fat milk solids, whey protein, casein) oils commonly used in edible emulsions including flavoring oils, and cooking oils (olive oil, corn oil, coconut oil, safflower oil, canola oil), flavoring extracts, flavoring syrups, water, vinegar or other acids (liquid or powdered), alcohol, fiber and fiber derived products, starches, gums, other edible hydrocolloids.

The type of food composition is not limited, but in various embodiments, the food composition comprising a saponin containing composition is one or more of the following: sauces, dressings, ice creams and frozen desserts, beverages, yogurts, bakery fillings and glazes, puddings, custards, or other cream or cream like desserts and dessert toppings, and thickened fruit preparations, cheese or cheese-like or analog cheese spreads and other edible spreads.

In various embodiments a food composition comprises a saponin containing composition that is modified compared to a seed flour to have smaller particles than the seed flour. In at least one embodiment a generally white food product (for example, including, but not limited to mayonnaise, white sauce, or white dressing) using saponin containing composition that is modified from a seed flour to have a generally smaller particle size than the seed flour and is whiter than the composition using the flour. In some embodiments, a food composition comprising a saponin containing composition that is modified from a seed flour to have a generally smaller particle size than the seed flour and has a whiteness value between about 0.5% and about 5% higher than the food product using the seed flour, or between about 0.75% and about 4.75%, or between about 1% and about 4.5% or between about 1% and about 4.25%, or between about 1% and about 4%.

In at least one embodiment this specification disclose a method of increasing the whiteness of a food composition comprising a saponin containing composition comprising mixing a saponin containing composition having a particle size distribution of between about 170 and about 230 mesh with a second edible ingredient thereby increasing the whiteness of the food composition compared to a test food composition being the same as the food composition except that it comprises a saponin containing composition having a particle size distribution of about 140 mesh or greater.

Use of “about” to modify a number in this specification is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” in this specification is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The technology is further described in the following aspects, which are intended to be illustrative, and are not intended to limit the full scope of the claims and their equivalents.

In a first aspect the technology pertains to a saponin containing composition obtained from a prairie carnation seed starch.

In a second aspect, the technology pertains to the composition of the first aspect further comprising between 1% and essentially 100% by weight of flower seed saponin, or between about 2 and about 90%, or about 2% and about 20%, or between about 2% and about 15%, or between about 2% and about 10%, or between about 2% and about 7%, or between about 2% and about 6%, or between about 2% and about 5%, or between about 2% and about 4%, or between about 10% and about 50%, saponin, or between about 10% and about 45%, or between about 10%, and about 40%, or between about 15% and about 40%, or between about 15% and about 39%, or between about 15% and about 37%, between about 20% and about 37%, between about 20% and about 35%, between about 20% and about 33%, or between about 20 and about 30%, or in an amount greater than about 60% or between about 50% and about 90%, between about 50% and about 75%, between about 50% and about 67%, or between about 50% and about 60%.

In a third aspect, the technology pertains to the composition the first or second aspect being powdered composition.

In a fourth aspect, the technology pertains to the composition of any of the first through third aspects having a particle size distribution having a mode of between about 10 and about 300 microns, or between about 10 and 250 microns, or between about 10 and about 200 microns, or between about 10 and about 150 microns, or between about 10 and about 100 microns or between about 10 and about 40 microns, or between about 50 and about 300 microns, or between about 50 and about 250, or between about 50 and about 200 or between about 50 and about 150, or between about 50 and about 100, or between about 50 and about 70 microns, or between about 100 and about 200 microns, or between about 200 and about 300 microns, or between about 10 and about 40 microns.

In a fifth aspect, the technology pertains to the composition of any one of the first to fourth aspects obtained by passing a milled powdered saponin composition through a sieve having screen of 80 mesh, or smaller than about 100 mesh, or smaller than about 120 mesh, or smaller than about 140 mesh, or smaller than about 170 mesh, or smaller than about 200 mesh, or smaller than about 230 mesh, or between about 80 mesh and about 230 mesh, or between about 80 and about 200 mesh, or between about 80 and about 170 mesh, or between about 100 mesh and about 170 mesh, or between about 100 mesh and about 200 mesh, or between about 100 mesh and about 230 mesh, or between about 120 mesh and about 230 mesh, or between about 140 mesh and about 230 mesh, or between about 170 mesh and about 230 mesh, or about 200 mesh.

In a sixth aspect, the technology pertains to the composition of any one of the first to fifth aspects further comprising a starch content between 40% and 80% starch by weight, or between about 45% and about 60%, or between about 45% and about 55%, or between about 45% and about 50%, or between about 50% and about 55% or between, about 50% and about 60%, or between about 55% and about 60%, or between about 60% and about 80% starch, or between about 60% and about 75%, or between about 60% and about 70%, or between about 61% and about 70%, or between about 62% and about 70%, or between about 63% and about 70%, or between about 64% and about 70%, or between about 65%, and about 70%, or between about 65% and about 71%, or between about 65% and about 72%, or between about 65% and about 73%, or between about 65% and about 74%, or between about 65% and about 75%.

In a seventh aspect, the technology pertains to the composition of any one of the first to sixth aspects further comprising a protein content of less than about 10%, less than about 7%, less than about 5%, less than about 4%, or less than about 2%, or between about 0.1% and about 10% by weight, or between about 15% and about 50% of the composition or between about 15% and about 40% or between about 15% and about 30% or between about 15% and about 25% or between about 15% and about 20% by weight of the composition.

In an eight aspect, the technology pertains to the composition of any one of the first to seventh aspects further comprising less than about 10% fiber, or less than about 7%, or less than about 5%, or less than about 3%, or less than about 1%, or between about 0.1% and about 10% by weight of the composition.

In a ninth aspect, the technology pertains to the composition of any one of the first to eighth aspects consisting essentially of the components of the prairie carnation seed.

In a tenth aspect, the technology pertains to a food composition comprising the saponin containing composition of any one of the first to ninth aspects.

In an eleventh aspect, the technology pertains to the food composition of the tenth aspect comprising an emulsion or being an emulsion.

In a twelfth aspect, the technology pertains to the food composition of the tenth or eleventh aspects being selected from the group consisting of sauces, dressings, ice creams, frozen desserts, beverages, yogurts, bakery fillings, glazes, puddings, custards, thickened fruit preparations, cheese spreads, or analog cheese spreads.

In a thirteenth aspect, the technology pertains to the food composition of any one of the tenth to twelfth aspects comprising between about 0.01% and about 50% by weight of the food composition, about 0.1% and about 10%, or between about 0.1% and about 5% or between about 0.1% and about 2.5% or between about 0.1% and about 2% or between about 0.1% and about 1.5% or between about 0.1% and about 1.4% or between about 0.1% and about 1.3% or between about 0.1% and about 1.2% or between about 0.1% and about 1.1% or between about 0.1% and about 1% or between about 0.2% and about 1% or between about 0.3% and about 1% or between about 0.4% and about 1% or between about 0.5% and about 1% or between about 0.6% and about 1% or between about 0.7% and about 1% or between about 0.8% and about 1%.

In a fourteenth aspect, the technology pertains to a method of making a saponin containing composition comprising: obtaining a milled carnation seed and at least one more processing step selected from group consisting of:

(a) soaking at least a portion of a carnation seed in an aqueous solution to obtain a saponin containing composition having between about 50 and about 90% by weight carnation seed saponin content; and

(b) separating at least a portions of the components of the milled carnation seed using dry process wherein, the components of the milled carnation seeds are separated based on at least one physical characteristic the components, and wherein the process produces a powdered composition having a particle size distribution having a mode having a mode of between about 10 and about 300 microns, or between about 10 and 250 microns, or between about 10 and about 200 microns, or between about 10 and about 150 microns, or between about 10 and about 100 microns or between about 10 and about 40 microns, or between about 50 and about 300 microns, or between about 50 and about 250, or between about 50 and about 200 or between about 50 and about 150, or between about 50 and about 100, or between about 50 and about 70 microns, or between about 100 and about 200 microns, or between about 200 and about 300 microns. or between about 10 and about 40 microns.

In a fifteenth aspect, the technology pertains to use of a saponin composition as described in or as obtained by any of the foregoing aspects as an emulsifier.

The following Examples are provided to further illustrated the invention as described above but are not limiting in any way.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

All publications, patent applications, issued patents, and other documents (for example, journals, articles and/or textbooks) referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### Example 1—Illustrative Food Products

The following formulations and methods of preparation illustrate use of saponin containing compositions in low fat savory applications, high fat savory applications, cook-up sauces, and instant sauces. All ingredient amounts are approximate. Formulations do not include amounts of common preservatives or stabilizers used (e.g. sodium benzoate, potassium sorbate, EDTA, etc.)

### Example 1A—Instant Sauce

An instant sauce (dressing like) formulation is presented in Table 2a. Instant sauces are cold formulations comprising low oil. The saponin containing composition is used as an egg replacement.

TABLE 2a
Instant Dressing

| Ingredient | Weight % |
|---|---|
| Water | 43.2 |
| Sugar | 11.5 |
| Vinegar | 8.1 |
| Starch | 4.5 |
| Salt | 1.7 |
| Soybean oil | 30.0 |
| Saponin Containing | 1.0 |
| Composition | |

Dry blend all ingredients. Add water and vinegar to a stainless-steel container. Slowly add dry blend to the water/vinegar while mixing on medium speed using KitchenAid mixer. Mix until mixture is homogenous. Slowly add oil while mixing at medium speed.

### Example 1B—Cook-Up Sauce

A cook-up sauce formulation is presented in Table 2b. Cook-up sauces are subjected to heat and comprise low oil content. The saponin containing composition is used to replace egg in an emulsion.

TABLE 2b
Cook-up dressing

| | Ingredient | Weight % |
|---|---|---|
| Part A | Water | 61.7 |
| (paste) | Sugar | 16.4 |
| | Vinegar | 11.7 |
| | Starch | 6.4 |
| | Salt | 2.4 |
| | Saponin Containing | 1.43 |
| | Composition | |
| Part B | Paste | 70 |
| | Soybean oil | 30 |

The process breaks into three parts. First, form a paste. Second, blend paste with oil to form a course emulsion. Third, further process to a fine emulsion. In more detail, to make the paste, blend dry ingredients. Disperse the dry mix into the water and vinegar. Heat mixture the dispersion in in boiling water bath and stir until paste thickens. Allow to cool and mix with oil to form coarse emulsion. To form final emulsion, continue mixing at increase speed for roughly 2 minutes.

### Example 1c—Vodka Sauce

Various sauces use mixtures of mono- and diglycerides as emulsifiers, for example vodka sauces (or other pasta sauces) and Chinese style sweet and sour sauces. Such sauces are also low oil, and the saponin containing composition is used to replace the mono- and diglycerides as the emulsifier. A recipe for an illustrative vodka sauces is set for in Table 2c

TABLE 2c
Simple vodka sauce

| Ingredient | Weight % |
|---|---|
| Water | 56.45 |
| Tomato paste | 25 |
| Heavy cream | 8.5 |
| Vodka | 4.0 |
| Olive oil | 3.0 |
| Starch | 1.0 |
| Sugar | 0.8 |
| Butter (melted) | 0.5 |
| Saponin containing composition | 0.75 |

Combine all dry ingredients (including emulsifier). Separately, combine all wet ingredients (excluding heavy cream). Mix dry ingredients with wet ingredients and stir. Pour mixture into Thermomix set to 195° F. at speed 2. Once temperature reaches 195° F., add in heavy cream and hold at temperature until thickened. Allow to cool and store.

### Example 1d—Chinese Style Sweet and Sour

Table 2d provides a formulation for a Chinese style sweet and sour sauce.

TABLE 2d
Chinese style sweet and sour sauce

| Ingredient | Weight % |
|---|---|
| Water | 55.25 |
| Sugar | 10 |
| Tomato paste | 7.0 |
| Pineapple juice | 5.0 |
| Honey | 4.0 |
| Sesame oil | 4.0 |
| Soy sauce | 3.0 |
| Starch | 3.0 |
| Vinegar | 3.0 |
| Orange juice | 2.0 |
| Lemon juice | 1.5 |
| Salt | 1.0 |
| Citric acid | 0.5 |
| Saponin containing composition | 0.75 |

Combine all dry ingredients (including emulsifier). Separately, combine all wet ingredients. Mix dry ingredients with wet ingredients and stir. Pour mixture into Thermomix set to 195° F. at speed 2 and hold at temperature until thickened. Allow to cool and store.

### Example 1e—High Fat Sauce

Table 2e provides a formulation for a high fat sauce and is based on a mayonnaise.

TABLE 2e
High fat sauce

| Ingredient | Weight % |
|---|---|
| Sugar | 2.7 |
| Salt | 1.2 |
| Saponin containing composition | 2.0 |
| Mustard oil | 0.2 |
| Lemon juice concentrate | 0.2 |
| Water | 20.5 |
| Vinegar | 2.0 |
| Soy bean oil | 71 |

Blend all dry ingredients. Add water to Hobart bowl and mix at speed 5 for 2 minutes. Add dry ingredients and scrape down side of bowl as necessary. Slowly add oil and mustard oil while mixing, then mix for 2 minutes. Add vinegar and lemon juice. Prepare final emulsion using Scott Turbon Mixer at 30 hertz for 2 minutes.

### Example 2—Rheology of Emulsions Comprising Saponin Containing Composition

Applicants evaluated various emulsion comprising a saponin containing composition derived from saponin flour, emulsions containing the saponin flour, and emulsions containing mono- and diglyceride emulsifiers, or egg emulsifier.

### Example 2a—Evaluation Methods

Applicants evaluated various rheological properties including droplet size, whiteness, and viscosity.

Droplet size was evaluated qualitatively using light microscopy. Samples were prepared as follows: Dilute sample to 1% starch concentration using pH 3 Buffer. Add approximately 200-300 μL of 0.1N iodine. Capture images that focus on fat globules at 200× magnification.

Particle size analysis was done using one of two methods. In example 2c, particle size was evaluated to Beckman Coulter LS 13 320 SW Laser Based Particle Size Analyzer. In examples 2b particle size was measured to produce a mean droplet size, which was obtained using a laser diffractor using a Mie analysis model. Additional particle size of the saponin containing composition was measured using the Beckman Coulter machine.

Instability index is a technique for measuring the stability of an emulsion using a LUMifuge® instrument (LUM GmbH). The technique and theory underlying it is described in Dispersion Letters Technical T4 (2014) 1-4, Update 14 (Detloff et al.) (ISBN: 978-3-944261-29-4).

Viscosity was measured using a Brookfield DV2T w/ heliopath moving upward, and T spindle C. Measurements were made over 30 seconds, and at 20 RPM.

Whiteness was measured using a colorimeter and are reported using a Hunter L value.

### Example 2b—Rheology of Emulsions Using Saponin Flour and Saponin Extract

Emulsification ability of saponin extract and saponin flour assessed an instant dressing and a cook-up sauce (Alfredo sauce) and benchmarked against numerous other emulsifier materials.

Instant dressings were made according to the formulation in Table 3a.

TABLE 3a
Instant dressings

| | Amount of ingredient (% w/w) | | | | | |
|---|---|---|---|---|---|---|
| Ingredient | Sample 1 | Sample 2 | Sample 3 | Sample 5 | Sample 6 | Sample 7 |
| Water | 39.5925 | 43.0925 | 43.0925 | 43.8425 | 43.0925 | 43.3425 |
| Sugar | 11.51 | 11.51 | 11.51 | 11.51 | 11.51 | 11.51 |
| Vinegar | 8.13 | 8.13 | 8.13 | 8.13 | 8.13 | 8.13 |
| Cold Water | 4.5 | 4.5 | 4.5 | 4.5 | 4.5 | 4.5 |
| Swelling Starch | | | | | | |
| Egg Yolk | 4.5 | 0 | 0 | 0 | 0 | 0 |
| Salt | 1.69 | 1.69 | 1.69 | 1.69 | 1.69 | 1.69 |
| Potassium Sorbate | 0.07 | 0.07 | 0.07 | 0.07 | 0.07 | 0.07 |
| EDTA | 0.0075 | 0.0075 | 0.0075 | 0.0075 | 0.0075 | 0.0075 |
| Soybean Oil | 30.00 | 30.00 | 30.00 | 30.00 | 30.00 | 30.00 |
| OSA modified | | 1.0 | | | | |
| starch | | | | | | |
| Pea protein | | | 1.0 | | | |
| isolate | | | | | | |
| Carnation Seed | | | | 0.25 | | |
| saponin (60% | | | | | | |
| saponin) | | | | | | |
| Carnation seed | | | | | 1.0 | |
| flour | | | | | | |
| Quillaja saponin | | | | | | 0.75 |
| Total | 100% | 100% | 100% | 100% | 100% | 100% |

Dressing were made by blending dry all ingredients to form a dry mix. Emulsifiers were included in the dry mix if in powder form. Liquids (excluding liquid emulsifier) were mixed in a stand prior to adding dry mix. Dry mix was slowly added and dressing was mixed using whisk attachment on medium speed until mixture was homogenous. Liquid emulsifier, including egg yolk, were added following homogenization, and mixture was mixed for one minute. Oil was then added at medium speed until coarse emulsion formed. Final emulsion was made by further mixing emulsion in 700 g samples (1 L beaker) at 30 hertz for 2 minutes.

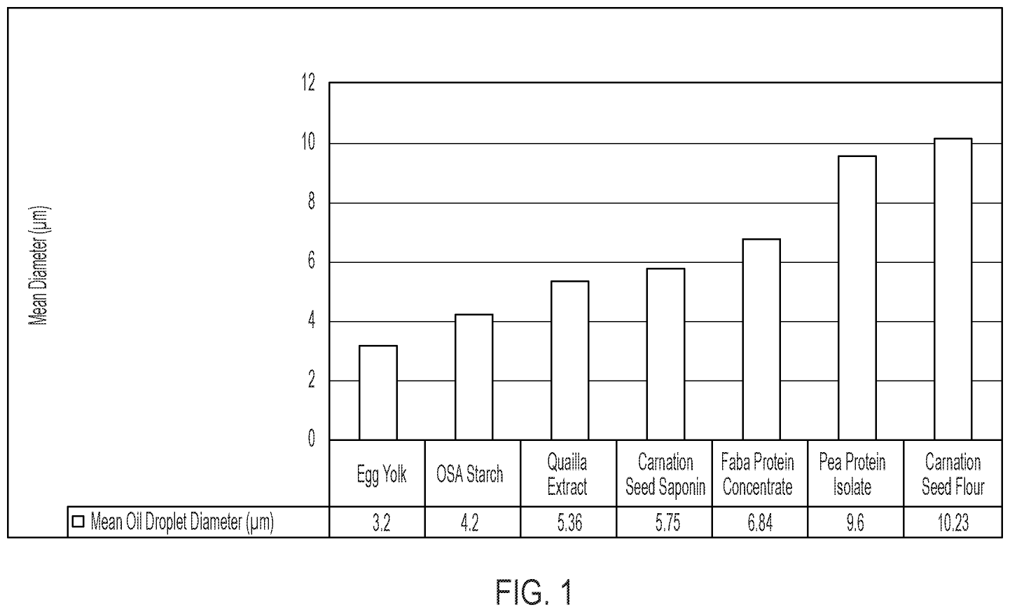

Mean droplet size of emulsions is reported in FIG. 1. Based on appearance and emulsion droplet mean diameter, emulsions having mean droplet diameter of less than 7 microns were deemed acceptable.

Cook up sauce (Alfredo sauce) formulation is listed in Table 3b.

TABLE NO 3b
Ingredients - Alfredo Sauce

| | Amount of ingredient (% w/w) | | | | | | | | | |
|---|---|---|---|---|---|---|---|---|---|---|
| | Control | Control | Sample | Sample | Sample | Sample | Sample | Sample | Sample | Sample |
| Ingredient | (Negative) | (Positive) | 11 | 12 | 13 | 14 | 15 | 16 | 17 | 18 |
| Water | 77.95 | 75.95 | 77.2 | 77.7 | 77.7 | 77.2 | 77.2 | 77.2 | 77.7 | 77.2 |
| Heavy Cream | 10 | 10 | 10 | 10 | 10 | 10 | 10 | 10 | 10 | 10 |
| Soybean Oil | 5 | 5 | 5 | 5 | 5 | 5 | 5 | 5 | 5 | 5 |
| Butter (Melted) | 3 | 3 | 3 | 3 | 3 | 3 | 3 | 3 | 3 | 3 |
| Modified food | 3 | 3 | 3 | 3 | 3 | 3 | 3 | 3 | 3 | 3 |
| starch | | | | | | | | | | |
| Salt | 0.5 | 0.5 | 0.5 | 0.5 | 0.5 | 0.5 | 0.5 | 0.5 | 0.5 | 0.5 |
| Sugar | 0.3 | 0.3 | 0.3 | 0.3 | 0.3 | 0.3 | 0.3 | 0.3 | 0.3 | 0.3 |
| Instant modified | 0.25 | 0.25 | 0.25 | 0.25 | 0.25 | 0.25 | 0.25 | 0.25 | 0.25 | 0.25 |
| starch | | | | | | | | | | |
| Enzyme Modified | 0 | 2 | 0 | 0 | 0 | 0 | 0 | 0 | 0 | 0 |
| Egg Yolk | | | | | | | | | | |
| OSA modified | | | 0.75 | | | | | | | |
| starch | | | | | | | | | | |
| Mono-diglycerides | | | | 0.25 | | | | | | |
| Soy Lecithin | | | | | 0.25 | | | | | |
| Fava bean protein | | | | | | 0.75 | | | | |
| concentrate | | | | | | | | | | |
| Pea protein | | | | | | | 0.75 | | | |
| isolate | | | | | | | | | | |
| Carnation seed | | | | | | | | 0.75 | | |
| flour | | | | | | | | | | |
| Carnation seed | | | | | | | | | 0.25 | |
| saponin | | | | | | | | | | |
| Quillaja extract | | | | | | | | | | 0.75 |
| Total | 100% | 100% | 100% | 100% | 100% | 100% | 100% | 100% | 100% | 100% |

Sauces were made as follows (some samples required slight modifications to the procedure). Combine starch, salt, and sugar with water in a large beaker and stir. Pour mixture into Thermomix. Set Thermomix to 195° F., speed 2. As heat increases, add melted butter (at about 130° F.), oil (at about 140° F.), and cream (at about 150° F.), emulsifier (at about 160° F.), and add cheese (at about 185° F.). Once temperature reaches 195° F., hold for 15 minutes and pour into separate 16 oz jars to cool (1000 g batches). Jars are cooled in ice bath and sauce is removed while still palpably warm. Sauce was transferred to two 1000 ml metal beakers (500 g samples) to homogenize using Scott Turbon mixer to blend batches of material at 20 hertz for 1 minute. Pour sauce into storage containers (4 oz jars) and store at 4° C.

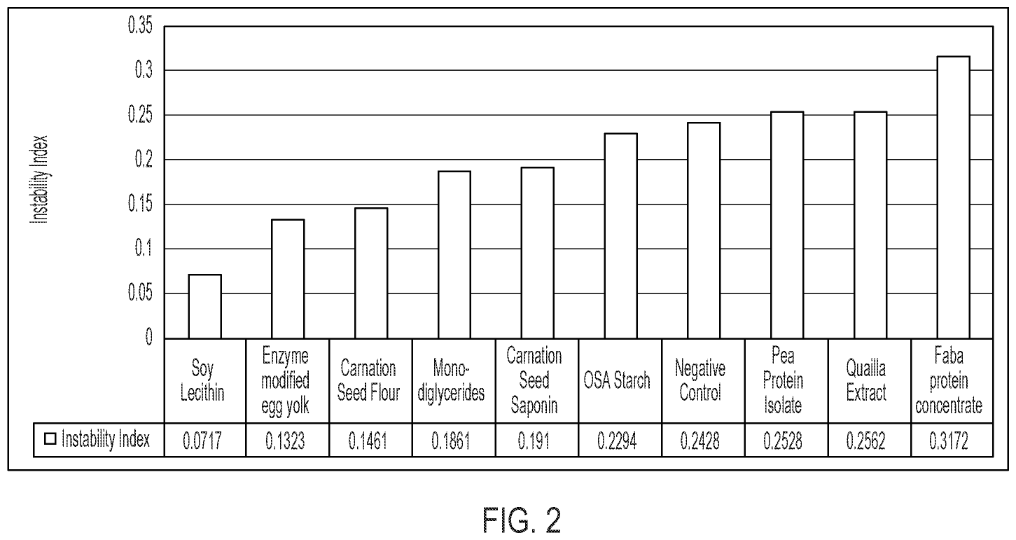

Samples were evaluated to generate a stability index and samples were deemed acceptable if their stability index fell below the negative control. Index stability results are reported in FIG. 2.

### Example 2c—Rheology of Emulsions Using Saponin Containing Composition

Applicants evaluated rheology of instant sauce, cook-up sauce, and high oil sauces comparing saponin containing compositions, saponin flour, egg and mono- and diglyceride emulsifiers.

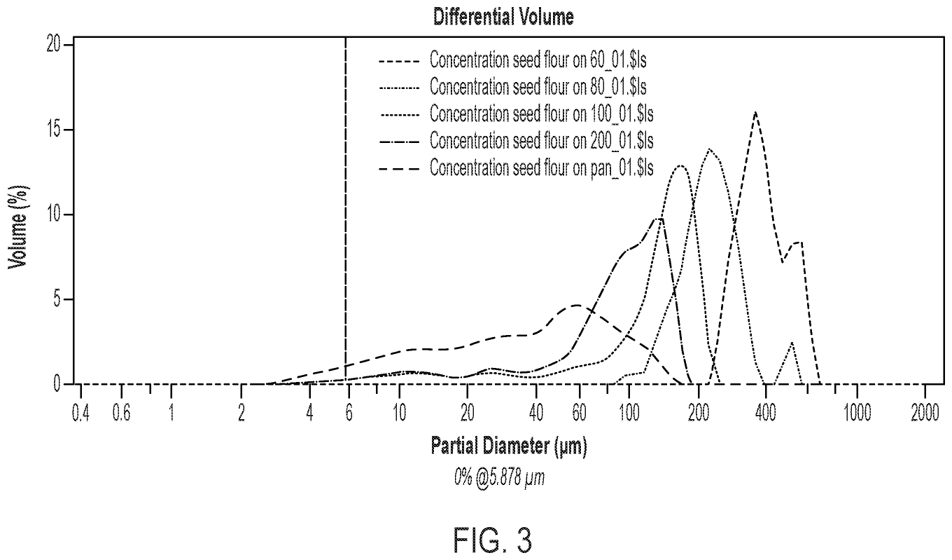

Saponin containing compositions having various particle size distributions were obtained from carnation seed flour using a Ro-tap Sieve Shaker having sieves of 80, 100, and 200 mesh, pan material was material of size sufficiently small to fall through a 200-mesh sieve. Particle size distribution of illustrative samples of saponin containing material are disclosed in FIG. 3

Instant sauces were made using the following formulations described in Table 3c.

TABLE 3c
Instant sauce

| | Sample number, and amounts by w/w (%) | | | | | |
|---|---|---|---|---|---|---|
| Ingredient | 1 | 2 | 3 | 4 | 5 | 6 |
| Water | 39.5925 | 43.0925 | 43.0925 | 43.0925 | 43.0925 | 43.0925 |
| Sugar | 11.51 | 11.51 | 11.51 | 11.51 | 11.51 | 11.51 |
| Vinegar (120 grain) | 8.13 | 8.13 | 8.13 | 8.13 | 8.13 | 8.13 |
| Starch | 4.5 | 4.5 | 4.5 | 4.5 | 4.5 | 4.5 |
| Salt | 1.69 | 1.69 | 1.69 | 1.69 | 1.69 | 1.69 |
| Potassium Sorbate | 0.07 | 0.07 | 0.07 | 0.07 | 0.07 | 0.07 |
| EDTA | 0.0075 | 0.0075 | 0.0075 | 0.0075 | 0.0075 | 0.0075 |
| Soybean oil | 30 | 30 | 30 | 30 | 30 | 30 |
| Egg yolk | 4.5 | | | | | |
| Seed flour | | 1.0 | | | | |
| 80 mesh | | | 1.0 | | | |
| 100 mesh | | | | 1.0 | | |
| 200 mesh | | | | | 1.0 | |
| Less than 200 mesh | | | | | | 1.0 |

The emulsions were made as follows. Dry blend all ingredients. Add water and vinegar to a stainless-steel container. Slowly add dry blend to the mixture #2 while mixing on medium speed using lighting mixer. Mix until mixture is homogenous (for control sample- add egg yolk at this step). Slowly add oil while mixing at medium speed. Use Scott Turbon mixer to blend 700 g of material in a 1 L beaker, mix at 30 hertz for 2 minutes.

Figure (4a) discloses the oil droplet size distribution over the self-life of the emulsions. Figure (4b) discloses the Hunter L value of the emulsions.

Cook-up sauces were made using the following formulations described in Table 3d.

TABLE 3d
Cook-up sauce

| | | Sample number, and amounts by w/w (%) | | | | | |
|---|---|---|---|---|---|---|---|
| Ingredient | | 1 | 2 | 3 | 4 | 5 | 6 |
| Part | Water | 60.189 | 61.519 | 61.519 | 61.519 | 61.519 | 61.519 |
| A-- paste | Sugar | 17.7 | 17.7 | 17.7 | 17.7 | 17.7 | 17.7 |
| | Starch | 6.9 | 6.9 | 6.9 | 6.9 | 6.9 | 6.9 |
| | Vinegar (120 grain) | 12.5 | 12.5 | 12.5 | 12.5 | 12.5 | 12.5 |
| | Salt | 2.6 | 2.6 | 2.6 | 2.6 | 2.6 | 2.6 |
| | Potassium Sorbate | 0.1 | 0.1 | 0.1 | 0.1 | 0.1 | 0.1 |
| | EDTA | 0.11 | 0.11 | 0.11 | 0.11 | 0.11 | 0.11 |
| | Seed flour | | 1.43 | | | | |
| | 80 mesh | | | 1.43 | | | |
| | 100 mesh | | | | 1.43 | | |
| | 200 mesh | | | | | 1.43 | |
| | Less than 200 mesh | | | | | | 1.43 |
| Part B | Paste | 65.5 | 70 | 70 | 70 | 70 | 70 |
| | Egg yolk | 4.5 | | | | | |
| | Soybean oil | 30 | 30 | 30 | 30 | 30 | 30 |

Cook-up sauces were made as follows were made in two parts, a paste, which was the mixed with oil to form the emulsion. For the paste, blend dry ingredients. Add water, vinegar, and dry mix to stainless steel beaker while stirring for complete dispersion. Heat mixture in boiling water bath for a total time of 5 minutes and stir by hand until paste begins to thicken (approximately 1-3 minutes), then cover with foil. Remove mixture from water bath and allow to cool at ambient temperature overnight. The paste was then mixed with oil to form a coarse emulsion. Add paste to Hobart mixing bowl and mix on speed 2-3 for 2 minutes. Stop and scrape bowl. Add oil slowly while mixing on speed 2-3 until all oil is incorporated into mixture. For control formula, add paste and egg yolk to Hobart mixing bowl and mix on speed 2-3 for 2 minutes. Stop and scrape bowl. The coarse emulsion was then further mixed with a Scott Turbon Mixer for 2 minutes at 30 hertz in 700 g in a 1 L beaker and was placed in 4-ounce and 2-ounce jars for evaluation.

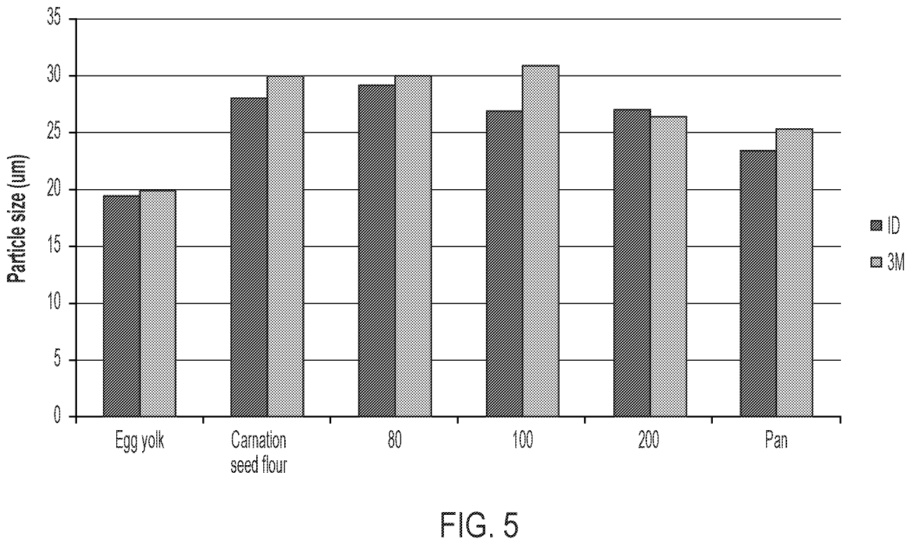

The oil droplet distribution over time is shown in FIG. 5.

Mono- and diglyceride replacement—the following sauces are made using saponin containing compositions, seed flour, and mono- and diglycerides. The formulations are set forth in Table 3e.

TABLE 3e
Mono- and diglyceride replacement

| | Sample number, and amounts by w/w (%) | | | | | |
|---|---|---|---|---|---|---|
| Ingredient | 1 | 2 | 3 | 4 | 5 | 6 |
| Water | 55.55 | 55.55 | 55.55 | 55.55 | 55.55 | 55.55 |
| Sugar | 10.0 | 10.0 | 10.0 | 10.0 | 10.0 | 10.0 |
| Tomato paste | 7.0 | 7.0 | 7.0 | 7.0 | 7.0 | 7.0 |
| Pineapple juice | 5.0 | 5.0 | 5.0 | 5.0 | 5.0 | 5.0 |
| Honey | 4.0 | 4.0 | 4.0 | 4.0 | 4.0 | 4.0 |
| Roasted sesame | 4.0 | 4.0 | 4.0 | 4.0 | 4.0 | 4.0 |
| seed oil | | | | | | |
| Soy sauce | 3.0 | 3.0 | 3.0 | 3.0 | 3.0 | 3.0 |
| Starch | 3.0 | 3.0 | 3.0 | 3.0 | 3.0 | 3.0 |
| Vinegar | 3.0 | 3.0 | 3.0 | 3.0 | 3.0 | 3.0 |
| Orange juice | 2.0 | 2.0 | 2.0 | 2.0 | 2.0 | 2.0 |
| Lemon juice | 1.5 | 1.5 | 1.5 | 1.5 | 1.5 | 1.5 |
| Salt | 1.0 | 1.0 | 1.0 | 1.0 | 1.0 | 1.0 |
| Citric acid | 0.5 | 0.5 | 0.5 | 0.5 | 0.5 | 0.5 |
| Sodium Benzoate | 0.1 | 0.1 | 0.1 | 0.1 | 0.1 | 0.1 |
| Potassium sorbate | 0.1 | 0.1 | 0.1 | 0.1 | 0.1 | 0.1 |
| Mono-diglycerides | 0.25 | | | | | |
| Seed flour | | 0.75 | | | | |
| 80 mesh | | | 0.75 | | | |
| 100 mesh | | | | 0.75 | | |
| 200 mesh | | | | | 0.75 | |
| Less than 200 | | | | | | 0.75 |

Methods for making the sauce are as follows. Combine all dry ingredients (including emulsifier). Separately, combine all wet ingredients. Mix dry ingredients with wet ingredients into large beaker and stir with a fork and pour mixture into Thermomix. Set Thermomix to 195° F., speed 2. Once temperature reaches 195° F., hold for 20 minutes. Pour into containers, and Cool in ice bath. Samples were stored at 22° C.

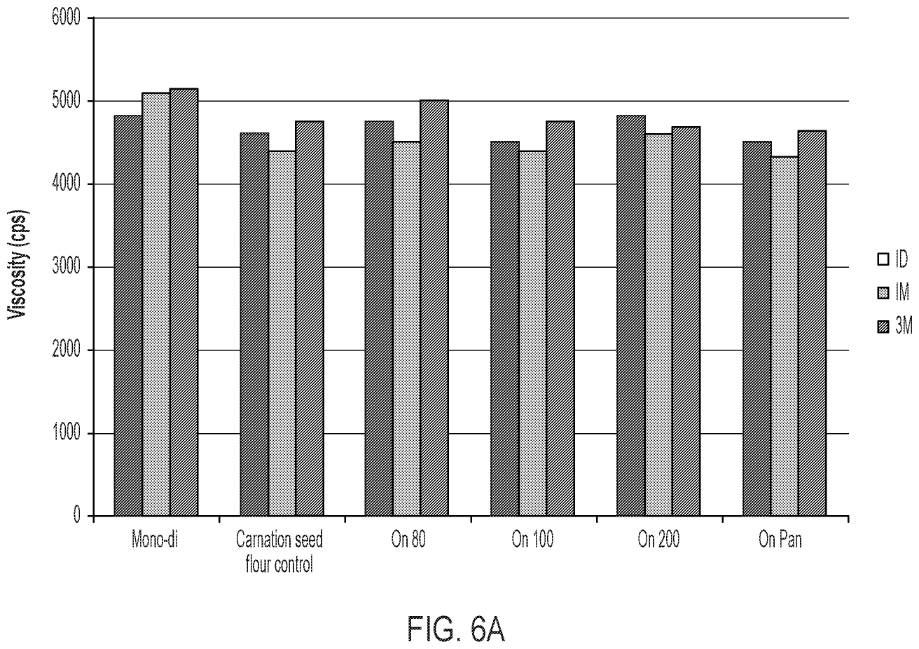

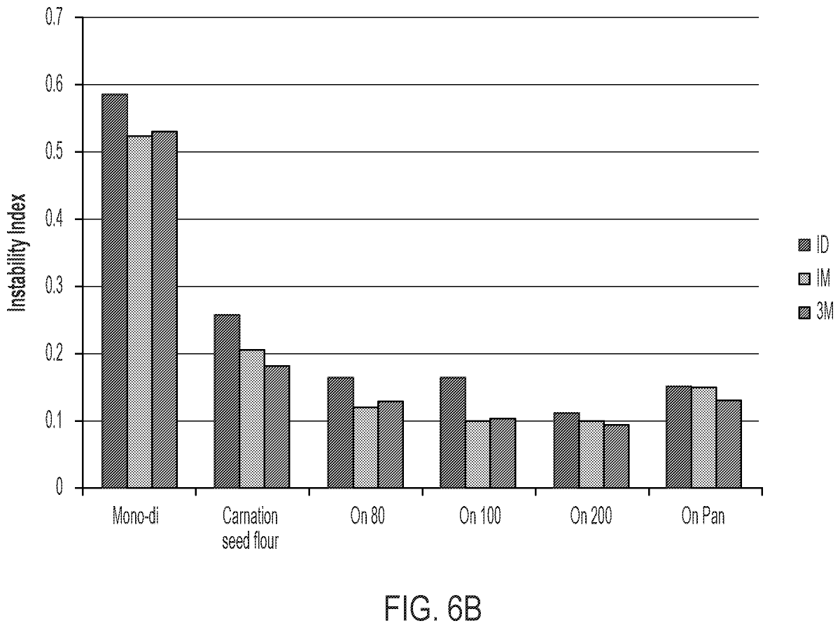

Viscosity of sauces over time is shown in FIG. 6a. The instability index of sauces over time is shown in FIG. 6b.

High fat emulsions were made using the formula set forth in Table 3f.

TABLE 3f
High fat emulsion

| | Ingredients | 1a | 1b | 1c | 1d | 2a | 2b | 2c |
|---|---|---|---|---|---|---|---|---|
| Dry mix | Starch | | | | | | 0.75 | 1.0 |
| | Sugar | 2.7 | 2.7 | 2.7 | 2.7 | 2.7 | 2.7 | 2.7 |
| | Salt | 1.2 | 1.2 | 1.2 | 1.2 | 1.2 | 1.2 | 1.2 |
| | EDTA | 0.075 | 0.075 | 0.075 | 0.075 | 0.075 | 0.075 | 0.075 |
| | Potassium | 0.1 | 0.1 | 0.1 | 0.1 | 0.1 | 0.1 | 0.1 |
| | sorbate | | | | | | | |
| | Seed flour | | | 1 | 1 | 2 | 1 | 1 |
| Wet mix | Mustard | 0.2 | 0.2 | 0.2 | 0.2 | 0.2 | 0.2 | 0.2 |
| | seed oil | | | | | | | |
| | Lemon juice | 0.2 | 0.2 | 0.2 | 0.2 | 0.2 | 0.2 | 0.2 |
| | concentrate | | | | | | | |
| | Water | 15.525 | 21.525 | 21.525 | 27.525 | 20.525 | 26.775 | 26.525 |
| | Vinegar | 2 | 2 | 2 | 2 | 2 | 2 | 2 |
| | (120 Grain) | | | | | | | |
| | Egg yolk | 7 | 7 | | | | | |
| | Soybean oil | 71 | 65 | 71 | 65 | 71 | 65 | 65 |

Emulsions were made as follows. Blend all dry ingredients. Add water (and egg) to Hobart bowl and mix at speed 5 for 2 minutes. Add dry ingredients and scrape down side of bowl as necessary. Slowly add oil and mustard oil while mixing then mix for 2 minutes. Add vinegar and lemon juice. Prepare final emulsion using Scott Turbon Mixer at 30 hertz for 2 minutes.

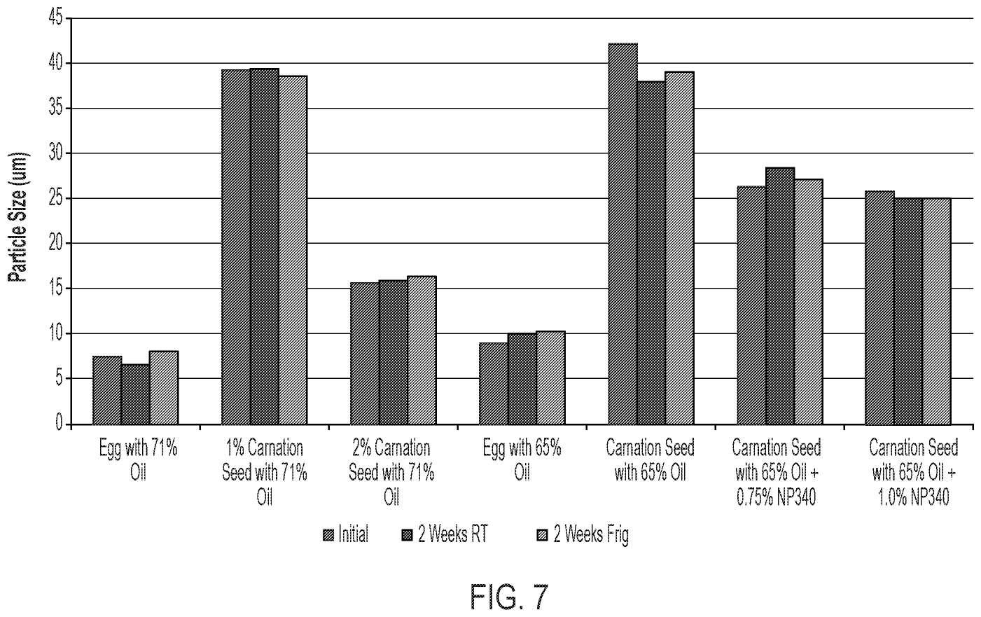

Oil droplet size distribution is reported in FIG. 7.

1. A saponin containing composition obtained from a prairie carnation seed starch.

2. The composition of claim 1 wherein the composition has saponin content from the prairie carnation seed of in a range selected from the group consisting of (a) between about 2% and about 20 (wt. %), (b) between about 20% and about 37% (wt. %), and (c) between about 50% and about 90% (wt. %).

3. The composition of claim 1 being in powdered form.

4. The composition of claim 1 having a particle size distribution having a mode of between about 10 and about 300 microns.

5. The composition of claim 1 obtained by passing a milled a powdered saponin composition through a sieving having screen of between about 80 mesh and about 230 mesh.

6. The composition of claim 1 further having a starch content between 40% and 80% starch by weight.

7. The composition of claim 1 further having a protein content of within a range selected from the group consisting of (a) less than about 10% by weight; and (b) between about 15 and about 50% of the composition by weight.

8. The composition of claim 1 further having less than about 10% fiber.

9. The composition of claim 1 consisting essentially of the components of the prairie carnation seed.

10. A food composition comprising the saponin containing composition of claim 1.

11. The food composition of claim 10 comprising an emulsion or being an emulsion.

12. The food composition of claim 10 being selected from the group consisting of sauces, dressings, ice creams, frozen desserts, beverages, yogurts, bakery fillings, glazes, puddings, custards, thickened fruit preparations, cheese spreads, or analog cheese spreads.

13. The food composition of claim 10 comprising the saponin containing composition in an amount between about 0.01% and about 50% by weight of the food composition.

14. A method of making a saponin containing composition comprising:
(a) obtaining a milled carnation seed and
(b) separating at least a portions of the components of the milled carnation seed using dry process
wherein the components of the milled carnation seeds are separated based on at least one physical characteristic the components, and
wherein the process produces a powdered composition having a particle size distribution having a mode of between about 10 and about 300 microns.

15. (canceled)
